(19) United States
(12) Patent Application Publication
(10) Pub. No.: US 2009/0056622 A1
(43) Pub. Date: Mar. 5, 2009

(54) Spray Guide

(76) Inventor: Terry Potter, Winter Garden, FL (US)

Correspondence Address: Timothy H. Van Dyke;Beusse Wolter Sanks Mora & Maire, P.A., Suite 2500, 390 North Orange Avenue, Orlando, FL, 32801, US

(21) Appl. No.: 11/849,677

(22) Filed: Sep. 4, 2007

(51) Int. Cl. B05B 3/00

(52) U.S. Cl. 118/323

(57) ABSTRACT

A spray guide is disclosed herein for implementation with a spray assembly comprising a spray wand and a spray nozzle. The spray guide includes an arm having a first end and a second end. A mechanism is used for removably attaching the first end of the arm to the swivel angle head, so that the arm will extend over the swivel angle head and the spray nozzle. A wheel is also provided. Another mechanism is provided for rotatably connecting the wheel to the second end of the arm. When an edge of the wheel is placed in a corner joint between a wall and a ceiling and the spray wand manually moved therealong, the wheel will rotate in the corner joint to allow paint to be evenly sprayed from the spray nozzle onto an area of the wall adjacent to the ceiling.

### FIELD OF THE INVENTION

The present invention relates to a paint sprayer accessory, and more particularly, paint spray guide.

### BACKGROUND

The conventional way of painting edges, especially wall edges near a ceiling is a very tedious, arduous process. It requires that a painter use a paint sprayer in one hand and a long handle paint shield in another hand. The painter must climb up a ladder with these two items in his hands, and paint a wall that he can reasonably reach. Then the painter must climb down the ladder, move it and climb back up to paint another region of the wall. This dramatically increases the time it takes a painter to paint, resulting in a much lower productively and earning potential for the painter.

U.S. Pat. No. 4,085,703 issued on Apr. 25, 1978 to Glowacki teaches a spray painting shield that includes a flat reinforcing member attached to an elongate handle. The shield permits a painter or his assistant to support the shield while keeping his arms and hands out of the spray pattern. The reinforcing member is attached to rotate relative one end of the handle. A spring clip mounted on the reinforcing member is used to hold large flat shields, many of which are disposable, for preventing paint from falling on selected areas. The flat shields may be cut or combined to conform with the perimeter of protected items, and the reinforcing member may conveniently include a metal edge used for scraping or occasional brush work.

U.S. Pat. No. 5,103,762 issued on Apr. 14, 1992, to Long et al. teaches a spray paint shield for manually protectively covering a portion of a wall or ceiling when the adjoining ceiling or wall portion, respectively, is being spray painted. The spray shield includes a generally flat, elongated sheet of thin, flexible material such as stainless steel or aluminum, having a straight distal or working edge and an elongated handle pivotally connected to, and extending from, the flat sheet at a mid point of the edge of the flat sheet opposite its distal edge. The handle is lockably positionable within the plane defined by the flat sheet at any convenient acute angle to the distal edge.

U.S. Patent Publication NO. 2005/0035221 A1, published on Feb. 17, 2005, to Gathright teaches a paint shield that includes two rigid sheets of material which are jointed in a perpendicular orientation. The angle of this joint matches the angle to an interior room wall or wall corner. The paint shield also includes an elongated handle mounted between the sheets and angling away from the joint. The handle may have a telescopic capability. The handle may also be positioned closer to a particular wall. The angle of the handle allows ambidextrous use of the paint shield, while providing unhampered access to spray painting the ceiling or floor corner. A painter may hold the shield against a wall corner, while spray painting the exposed ceiling or floor and masking the protected wall surfaces.

U.S. Pat. No. 7,063,275 B2 issued on Jun. 20, 2006, to Bryon teaches a sprayer having a spray shield and a spray shield retainer. The spray shield is removably attached to the spray shield retainer for efficient storage when not in use. The spray shield can be contoured to the body of the sprayer. The spray shield is configured for attachment to a spray wand proximate to a nozzle.

It is apparent now that different paint shields are present in the prior art that are adequate for various purposes. However, the aforementioned references do not disclose the elements of embodiments of the present invention and fail to contemplate the unique and advantageous aspects of various embodiments of the invention.

### SUMMARY OF THE INVENTION

Certain embodiments of the present invention provide a paint spray guide that dramatically decreases the time required for painting edges and is simple to use.

One embodiment of the present invention provides a paint spray guide for a swivel angle head located between a spray wand of a paint sprayer and a spray nozzle which comprises an arm having a first end and a second end. A mechanism is for removably attaching the first end of the arm to the swivel angle head, so that the arm will extend over the swivel angle head and the spray nozzle. A wheel is also provided. Another mechanism is for rotatably connecting the wheel to the second end of the arm. When an edge of the wheel is placed in a corner joint between a wall and a ceiling and the spray wand is manually moved therealong, the wheel will rotate in the corner joint to allow paint to be evenly sprayed from the spray nozzle onto an area of the wall adjacent the ceiling.

The novel features which are considered characteristics of certain embodiments of the present invention are set forth in the appended claims. Embodiments of the invention relating to construction and method of operation embodiments, together with additional advantages thereof, will be best understood from the following description of the specific embodiments when read and understood in connection with the accompanying drawings.

### BRIEF DESCRIPTION OF THE DRAWINGS

The figures of the drawings are briefly described as follows:

FIG. 1 is a rear perspective view of an embodiment of the invention per se;

FIG. 2 is a side perspective view of an embodiment of the present invention attached to a swivel angle head located between a spray wand of a paint sprayer and a spray nozzle;

FIG. 3 is a bottom perspective view showing an embodiment of the present invention in use when paint is sprayed on a wall adjacent to a ceiling; and

FIG. 4 shows a side perspective of another embodiment of the present invention.

### REFERENCE NUMERALS UTILIZED IN THE DRAWINGS

10 paint spray guide
12 swivel angle head
14 spray wand
16 spray nozzle
18 arm of paint spray guide 10
20 first end of arm 18
22 second end of arm 18
24 removably attaching mechanism of paint spray guide 10
26 wheel of paint spray guide 10
28 rotatably connecting mechanism of paint spray guide 10
30 edge of wheel 26
32 cornerjoint
34 wall
36 ceiling
38 Paint
40 C-clamp member of removably attaching mechanism 24
42 thumbscrew of removably attaching mechanism 24
44 aperture in second end 22 of arm 18
46 stub shaft of rotatably connecting mechanism 28
48 fastener of rotatably connecting mechanism 28
50 curved bumper member of paint spray guide 10
60 spray guide
61 spray assembly
62 wheel
64 arm
66 spray nozzle
67 clamp
68 wand
69 hinge

### DETAILED DESCRIPTION

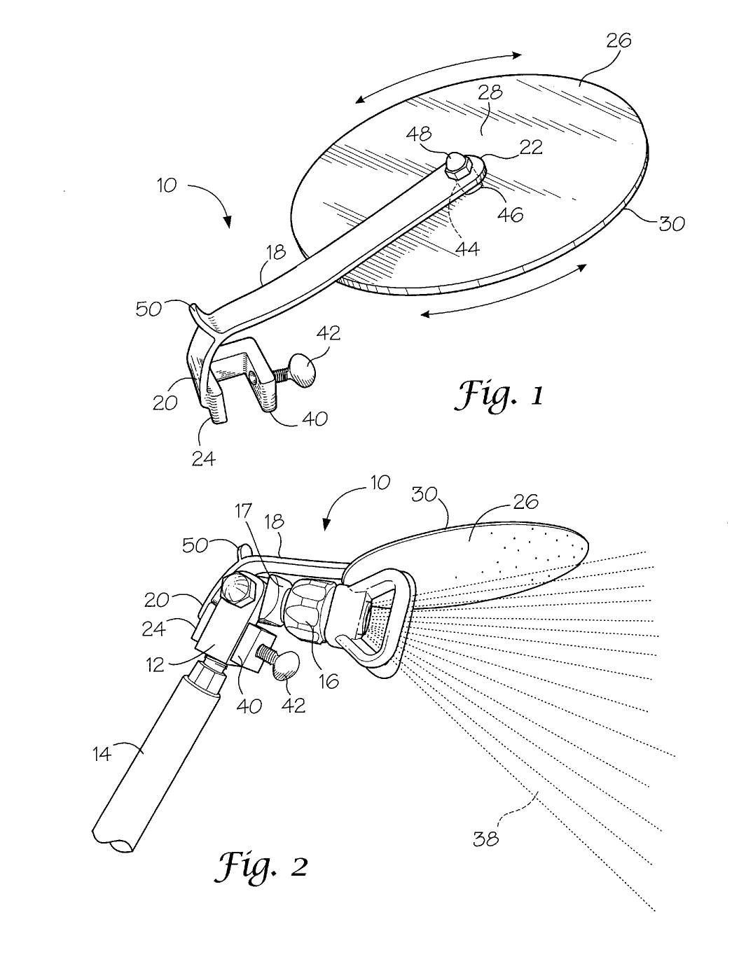

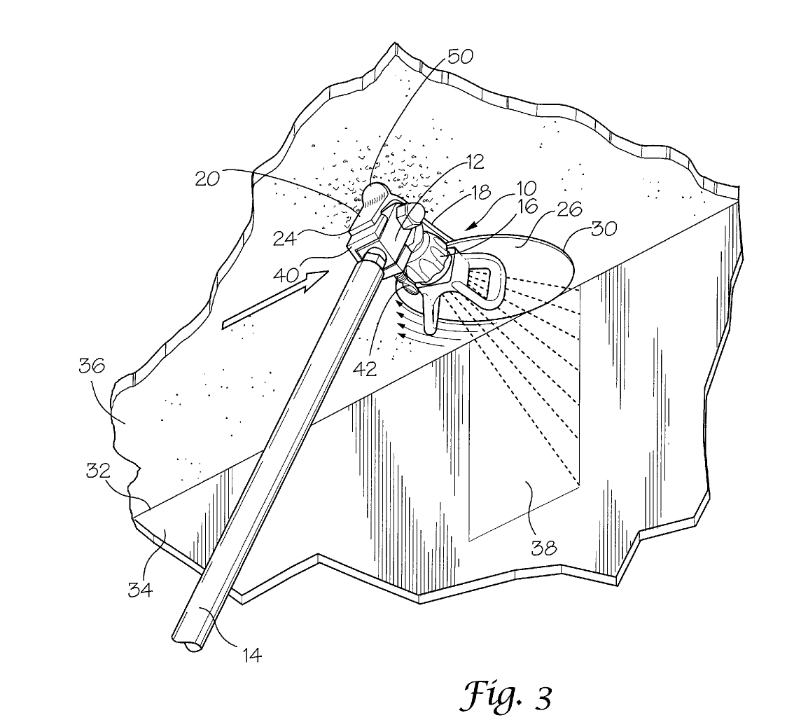

Referring now to the figures, in which like numerals indicate like parts, and particularly to FIGS. 1 through 3, which are a rear perspective view of an embodiment of the present invention per se; a side perspective view of an embodiment of the present invention attached to a swivel angle head located between a spray wand of a paint sprayer and a spray nozzle; and a bottom perspective view showing an embodiment of the present invention in use when paint is sprayed on a wall adjacent to a ceiling, and as such, will be discussed with reference thereto.

According to one embodiment, the present invention pertains to a paint spay guide 10 for a spray assembly 11 comprising a swivel angle head 12 located between a spray wand 14 of a paint sprayer (not shown) and a spray nozzle 16. The pain spray guide 10 comprises an arm 18 having a first end 20 and a second end 22. A mechanism 24 is for removably attaching the first end 20 of the arm 18 to the swivel angle head 12 so that the arm 18 will extend over the swivel angle head 12 and the spray nozzle 16. A wheel 26 is also provided. Another mechanism 28 is for rotatably connecting the wheel 26 to the second end 22 of the arm 18. When an edge 30 of the wheel 26 is placed in a cornerjoint 32 between a wall 34 and a ceiling 36 and the spray wand 14 is manually moved therealong, the wheel 26 will rotate in the corner joint 32 to allow paint 38 to be evenly sprayed onto an area of the wall 34 adjacent to the ceiling 36 from the spray nozzle 16.

The removably attaching mechanism 24 comprises a C-clamp member 40 affixed to the first end 20 of the arm 18. A thumbscrew 42 is threaded into the C-clamp member 40. When the thumbscrew 42 is tightened, the C-clamp member 40 will become attached to the swivel angle head 12. The wheel 26 is sized to prevent paint 38 sprayed from the spray nozzle 16 to make contact with the ceiling 36 when the wall 34 adjacent to the ceiling 36 is being painted. The C-clamp is believed to be a sturdy and facile means for attaching the spray guide. However, it is contemplated that other configurations for attaching the spray guide to the spray assembly may be implemented, such as, but not limited to, a nut and bolt through the spray assembly and through the arm, a hose clamp surrounding the spray assembly and holding the arm thereto, a slot defined in the assembly for the arm to slide into, or a flat extension on the spray assembly for sliding into a slot defined on the arm, etc.

The rotatably connecting mechanism 28 comprises the second end 32 of the arm 18 having an aperture 44 therethrough. A stub shaft 46 is mounted on the center of the wheel 26. The stub shaft 46 extends upwardly through the aperture 44 in the second end 22 of the arm 18. A fastener 48 engages with the stub shaft and holds the wheel 26 to the second end 22 of the arm 18 while allowing the wheel 26 to rotate.

In an alternative embodiment, the paint spray guide 10 further comprises a curved bumper member 50 affixed to and extending upwardly from the arm 18 near the removably attaching mechanism 24. The curved bumper member 50 will bear against the ceiling 36 to properly position the spray nozzle 16 towards the area of the wall 34 adjacent to the ceiling 36. The arm 18, the removably attaching mechanism 24, the wheel 34, the rotatably connecting mechanism 28 and the curved bumper member 50 are all fabricated out of a stainless steel material. Those skilled in the art will appreciate that some or all of the components can be made from other suitable materials including, but not limited to, plastics, wood, other metals and alloys etc. or a combination thereof. In another alternative embodiment, the curve member may be substituted with any suitable extended structure from said arm that facilitates the maintenance of an even bearing across a surface, including but not limited to a wheel attached to the arm 18 between said first and second arm ends 20, 22.

In other embodiments, the swivel head has an orthogonal structure other than a square or rectangular structure, such as, but not limited to, pentagonal, hexagonal, etc, or a rounded structure, e.g., cylindrical. While the embodiment described in FIGS. 1-3 above includes a swivel angle head that associates the spray nozzle to the spray wand, the assembly is not limited to including a swivel head or any head. Those skilled in the art in view of the teachings herein will appreciate that there are many types of assemblies that associate a spray nozzle with a spray wand, including, but not limited to, some that may swivel, some that may be generally square or rectangular, such as that shown in the drawings, some may be cylindrical, or, in certain embodiments, the assembly comprises a direct connection between the spray nozzle and the end of a wand without an intervening head, per se.

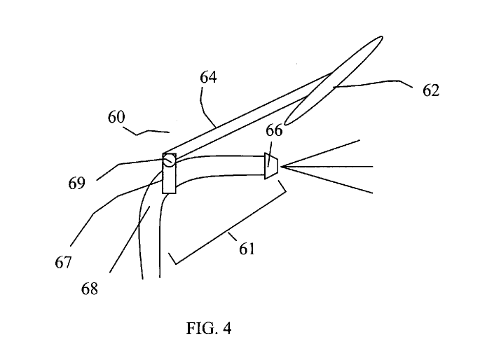

In another alternative embodiment as shown in FIG. 4, a spray guide 60 is designed for implementation with a spray assembly 61 that comprises a nozzle 46 engaged directly to a wand 68. The nozzle may be rotated or adjusted. The spray guide 60 comprises a wheel 62 rotatably attached to an arm 64. The arm 64 is attached to the spray assembly 61 via implementation with a clamp 67 tightened around the wand 68. The arm 64 is pivotably engaged to the clamp 67 by a hinge 60. The wheel of spray guide 60 (or 10) is adjusted so that the spray slightly fogs the edge of the wheel. This avoids build up of fluid on the wheel, which can result in dripping.

It is apparent in view of the teachings herein that embodiments of the invention are particularly useful for applying paint to a surface comprising a corner. It will be understood that embodiments of the invention can be useful for the application of any suitable fluid, whether paint or otherwise, that is sprayed onto a surface of a fluid spraying system comprising a wand and nozzle.

It will be understood that each of the elements described above, or two or more together, may also find a useful application in other types of constructions differing from the types described above.

While the invention has been illustrated and described as embodiments of a spray guide, accordingly it is not limited to the details shown, since it will be understood that various omissions, modifications, substitutions and changes in the forms and details the device illustrated and its operation can be made by those skilled in the art without departing in any way from the sprint of the present invention. The teachings of all of the references cited herein are incorporated by reference to the extent not inconsistent with the teachings herein.

1. A spray guide for implementation with a fluid spraying system, the system including a spray assembly comprising a spray wand and a spray nozzle, said spray guide comprising:
a) an arm having a first end and a second end;
b) a first connector for removably attaching said first end of said arm to the spray assembly;
c) a wheel; and
d) a second connector for rotatably connecting said wheel to said second end of said arm, whereby when an edge of said wheel is placed in a corner joint between a wall and a ceiling and the spray wand is manually moved therealong, said wheel will rotate in the corner joint to allow paint to be evenly sprayed from the spray nozzle onto an area of the wall adjacent to the ceiling.

2. The spray guide as recited in claim 1, wherein said first connector comprises:
a) a C-clamp member affixed to said first end of said arm; and
b) a thumbscrew threaded into said C-clamp member, whereby when said thumbscrew is tightened said C-clamp member will become attached to the swivel angle head.

3. The spray guide as recited in claim 1, wherein said wheel is sized to prevent paint sprayed from the spray nozzle to make contact with the ceiling when the wall adjacent to the ceiling is being sprayed.

4. The spray guide as recited in claim 1, wherein said second connector comprises:
a) a second end of said arm having an aperture therethrough;
b) a stub shaft mounted on center of said wheel, whereby said stub shaft extends upwardly through said aperture in said second end of said arm; and
c) a fastener which engages with said stub shaft and holds said wheel to said second end of said arm, while allowing said wheel to rotate.

5. The spray guide as recited in claim 1, further comprising a curved bumper member affixed to and extending upwardly from said arm, whereby said curved bumper member will bear against the ceiling to properly position the spray nozzle toward the area of the wall adjacent to the ceiling.

6. The paint spray guide as recited in claim 5, wherein said arm, said first connector, said wheel, said second connector, and said curved bumper member are all fabricated out of a stainless steel material.

7. A paint spray guide for implementation with a fluid spraying system, the system including a spray assembly comprising a spray wand and a spray nozzle, said spray guide comprising:
a) an arm having a first end and a second end;
b) a first connector for removably attaching said first end of said arm to the spray assembly, so that said arm will extend over the swivel angle head and the spray nozzle;
c) a wheel;
d) a second connector for rotatably connecting said wheel to said second end of said arm; and
e) a curved bumper member affixed to and extending upwardly from said arm between said first and second connectors, whereby when an edge of said wheel is placed in a corner joint between a wall and a ceiling and the spray wand is manually moving therealong, said wheel will rotate in the corner joint to allow paint to be evenly sprayed from the spray nozzle onto an area of the wall adjacent to the ceiling, while said curved bumper member will bear against the ceiling to properly position the spray nozzle toward the area of the wall adjacent to the ceiling.

8. The spray guide as recited in claim 7, wherein said first connector comprises:
a) a C-clamp member affixed to said first end of said arm; and
b) a thumbscrew threaded into said C-clamp member, whereby when said thumbscrew is tightened said C-clamp member will become attached to the swivel angle head.

9. The spray guide as recited in claim 7 wherein said wheel is sized to prevent paint spraying from the spray nozzle to make contact with the ceiling when the wall adjacent to the ceiling is being painted.

10. The spray guide as recited in claim 7, wherein said second connector comprises:
a) a second end of said arm having an aperture therethrough;
b) a stub shaft mounted on center of said wheel, whereby said stub shaft extends upwardly through said aperture in said second end of said arm; and
c) a fastener which engages with the stub shaft and holds said wheel to said second end of said arm, while allowing said wheel to rotate.

11. The spray guide as recited in claim 7, wherein said arm, said first connector, said wheel, said second connect and said curved bumper member are all fabricated out of a stainless steel or aluminum.

12. The spray guide of claim 1, wherein said arm comprises an angled portion.

13. A fluid spraying system comprising:
a) a spray assembly that comprises a spray wand and a spray nozzle;
b) an arm having a first end and a second end, wherein said arm is removably attached to said spray assembly at said first end;
c) a wheel rotatably attached to said arm at said second end;
whereby when an edge of said wheel is placed in a corner joint between a wall and a ceiling and the spray wand is manually moved therealong, said wheel will rotate in the corner joint to allow fluid to be evenly sprayed from the spray nozzle onto an area of the wall adjacent to the ceiling.

14. The fluid spraying system of claim 13, wherein said spray assembly further comprises a head situated between said wand and said nozzle.

15. The fluid spraying system of claim 14, wherein said head is orthogonal or rounded.

16. The fluid spraying system of claim 14 wherein said head is square and said arm is attached to said head via a removable clamp.

17. The fluid spraying system of claim 14, wherein said head comprises a slot defined therein in which said arm is inserted.

18. The fluid spraying system of claim 13, wherein said arm is attached to said spray assembly via a removable clamp.
